(19) United States
(12) Patent Application Publication
(10) Pub. No.: US 2002/0090428 A1
(43) Pub. Date: Jul. 11, 2002

(54) Treatment fluid application apparatus for foodstuffs and methods related thereto

(76) Inventors: C. Cayce Warf JR., (US); Scott D. Hageman, (US); Matthew C. Piazza, (US); Timothy G. Richardson, (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/004,277

(22) Filed: Oct. 9, 2001

Related U.S. Application Data
(60) Provisional application No. 60/240,302, filed on Oct. 12, 2000.

(51) Int. Cl. A23L 1/31

(52) U.S. Cl. 426/281

(57) ABSTRACT

Apparatus and methods for applying treatment fluids, such as disinfectants, flavoring agents, and tenderizing agents, to foodstuff surfaces to, for example, reduce populations of microorganisms or fungi, alter taste, or alter texture. In representative embodiments, the apparatus includes a housing, a fluid delivery system, and a shaft with a protruding surface, the latter adapted to rotatably convey, while agitating and tumbling, the foodstuffs from an inlet to an outlet of the housing, as the fluid delivery system applies a treatment fluid to the foodstuffs. In more specific embodiments, the protruding surface may be paddles, or paddles interconnected by a solid web and having angled distal surfaces, or a spiral blade with radial protrusions, or such a spiral blade along a first longitudinal portion of the shaft and paddles along a second longitudinal portion of the shaft.

### CROSS-REFERENCE TO RELATED APPLICATION

This application claims the benefit of U.S. Provisional Patent Application No. 60/240,302 filed Oct. 12, 2000 which provisional application is incorporated herein by reference in its entirety.

### BACKGROUND OF THE INVENTION

1. Field of the Invention

The present invention relates to the treatment of foodstuffs to improve edibility, longevity, and/or appearance, primarily by removing contamination, and, toward the latter end, more particularly, to the application of disinfecting and fungicidal fluids to foodstuff surfaces to deactivate bacterial and fungal populations found thereon.

2. Description of the Related Art

Treatment of fresh foodstuffs for the purpose of improving edibility, longevity, and/or appearance is primarily directed to the removal of surface contamination. Fresh foodstuffs, including meats (e.g., beef, pork, poultry, etc.), seafood (e.g., fish and shellfish), fruits, and vegetables, are susceptible to surface contamination by various microorganisms, some of which are pathogenic. Improper cooking, as well as the spread of microorganisms via physical transfer to hands, food handling surfaces, and other foods, can result in gastrointestinal disorders that, in some cases, lead to death. Also, fungi and bacteria can deleteriously affect the appearance, taste, and smell of a variety of foodstuffs.

It has been reported that a high percentage of meats and seafood have surface contamination. For example, organisms in intestinal tracts may contact meat surfaces immediately after slaughter and evisceration. Bacterial examples include Salmonella and Campylobacter species, Listeria monocytogenes, Eschherichia coli, and other coliforms. Once bacteria such as Salmonella contact tissue surfaces, they rapidly attach and are difficult to remove. In beef processing, for example, a particularly virulent strain of E. coli, designated O157:E7, reportedly contaminated hamburger meat sold by a fast-food chain and caused several deaths in the United States in 1993. Salmonella typhimurium and Campylobacter jejuni are two organisms of significant concern in the poultry industry. It has been estimated that 35%-45% of the poultry reaching consumers is contaminated with Salmonella species. Breeders, hatcheries, feed ingredient suppliers, farms, processors, and distributors have all been implicated as contributors to such contamination in chickens and turkeys (Villarreal, M. E. et al., J. of Food Protection 53:465-467 (1990)). Contamination of only a few birds can lead to broader range contamination of other birds and cross-contamination to carcasses. It is not uncommon for E. coli to also contaminate seafood. In a recent study, 3-8% of samples of fresh fish purchased at supermarkets were found to have unacceptable levels of E. coli.

Fruits and vegetables, especially organic produce, often have surface contamination from various organisms, some of which are pathogenic, and which include bacteria, fungi, and nematodes (i.e., roundworms and threadworms). Contamination may occur during the growing season. Fields may be contaminated from wild animal feces or fertilization with manure-related products. Organic produce farmers often use fertilizer made from animal waste, rather than synthetic fertilizers. Composting the manure to kill the dangerous bacteria found therein is not always effective. Conventional farmers may also use manure. In addition, E. coli and other microbial infections may be present in pond water used to irrigate fields. Contamination of produce by fungi and bacteria may also occur during harvesting and storage and may arise from repeated handling of the produce, from the containers used for harvesting and storage, from processing and packaging equipment, from storage warehouse surfaces, and from the water used in post-harvest treatment or to clean warehouses. Some bacteria present on fruit and vegetable surfaces, such as Erwinia spp. and Pseudomonas spp., cause rot. Other bacteria are pathogenic. For example, Yersinia enterocolitica causes diarrhea, and Listeria monocytogenes causes listeriosis, a sometimes-fatal encephalitic disease. Examples of fungi are Alternaria sp. (causes black rot), Sclerotinia sclerotiorum (causes white mould), Botrytis cineria (causes gray mold), Acremonium apii (causes brown stain), and Phoma sp. (causes gangrene).

The rate of bacterial and fungal proliferation and resulting damage and health risk can, to some extent, be diminished by refrigeration, but there is a limit to the degree of refrigeration that can be imposed on meat, poultry, seafood, fruit, and vegetable products. Also, while freezing may be effective, this is not an option where such products are to be sold as “fresh.” Furthermore, some bacteria such as psychrophiles can survive and even flourish at temperatures approaching the freezing point. It is thus advantageous to control, destroy, or deactivate microbial and fungal contaminants during processing to reduce the initial population of organisms and/or fungi on the surface of foodstuffs. This approach has been appreciated in the art, and, accordingly, a variety of disinfecting and fungicidal chemical treatments have been applied to the surfaces of foodstuffs. Examples of such treatments include: ozonated water, acidified sodium chlorite, aqueous chlorine, quaternary ammonium solutions, phenolic compounds, and formaldehyde solutions.

However, methods of applying such chemical treatments, found in the prior art, are either inefficient in terms of utilization of the chemicals so as to minimize waste, or are ineffective, or simply not feasible, in treating a multitude of small-sized foodstuffs, such as fruits, vegetables, and seafood, or foodstuff parts, such as cut-up meat and seafood parts. For example, foodstuffs or foodstuff parts, regardless of their size, can be thoroughly contacted and effectively treated for surface contamination by microorganisms or fungus by dipping or otherwise being immersed in a bath or tank containing the appropriate chemical solution. However, this method has a number of drawbacks. First, it is inherently wasteful. Organic debris, destined to be discarded, inevitably ends up in the bath and consumes active chemical components as the latter attack the surface contaminants on the debris. Second, the contents of such baths become contaminated and, at some point, need to be discarded, even though they still contain unconsumed active chemicals. Finally, replacing the contents of chemical baths can be labor intensive.

Methods for treating surface contamination of foodstuffs by spray application of disinfecting and fungicidal chemical solutions are also known and practiced in the art. For example, a basic approach is to convey whole or partial animal carcasses past a plurality of spray applicators (i.e., nozzles) dispensing disinfectant while otherwise keeping the carcasses substantially immobilized (i.e., suspended from hooks). The entire surface, including interior surfaces of opened body cavities, can be effectively treated, given a sufficient number of spray applicators properly positioned and delivering a sufficient quantity of solution by means of effective spray patterns (see, e.g., U.S. Pat. No. 4,849,237 to Hurst).

However, while this approach may be feasible and effective for applying disinfectant to the surfaces of whole or partial animal carcasses, it is not suitable for treating the surfaces of a multitude of small-sized foodstuffs or foodstuff parts. Examples of small-sized foodstuffs that may need to be treated include fruits, vegetables, and seafood. Examples of foodstuff parts that may need to be treated include cut-up meat and seafood parts.

Accordingly, there remains a need in the art for improved apparatus and methods for the efficient and effective application of disinfectants and fungicides to foodstuffs and foodstuff parts that can be readily integrated with an overall foodstuff processing plant. There also remains a need in the art for such apparatus and methods for the efficient and effective application of other treatment fluids, such as seasonings, marinades, tenderizers, texturizers, and preservatives, to otherwise improve the edibility, longevity, and appearance of foodstuffs. The present invention fulfills these needs and provides further related advantages.

### BRIEF SUMMARY OF THE INVENTION

The present invention relates to apparatus and methods for use in applying treatment fluids to the surface of whole foodstuffs or parts thereof for the purpose of improving their edibility, longevity, and/or appearance. For example, disinfecting or fungicidal fluids may be applied to foodstuff surfaces to diminish or eliminate populations of microorganisms or fungi found thereon, thereby improving the edibility, longevity, and appearance of the foodstuff. In a number of embodiments, the fluids are applied as a spray while the whole foodstuffs or parts thereof are conveyed from the inlet end to the outlet end of the apparatus. Foodstuffs thereby treated include meat parts (e.g., parts of beef, pork, lamb, poultry, etc.) as well as poultry, seafood, fruits, and vegetables—in whole form or in parts. Typically, for removal of contamination, meat and seafood are treated with disinfectants, while fruits and vegetables are treated with disinfectants and/or fungicides.

In one embodiment, the present invention is directed to a treatment fluid applicator for treatment of foodstuffs that comprises: a housing structure, a rotatable shaft having a plurality of paddles coupled to it and protruding from it, and a fluid delivery system. The shaft and paddles reside within the housing structure and rotate to convey, while agitating and tumbling, the foodstuffs along the housing structure while the fluid delivery system applies a treatment fluid to the surfaces of the foodstuffs. In specific embodiments, the paddles are generally fan blade-shaped with distal ends that have first and second bends, the paddles and bends generally being oriented at differing angles toward the outlet end of the housing structure. Also, the fluid delivery system comprises one or more manifolds, typically pipes, located above the shaft and paddles, and fitted with a plurality of spray nozzles that direct spray downward onto the foodstuffs being conveyed. In one embodiment, the fluid delivery system is enclosed in the housing structure by a lid installed over the top of the housing structure.

In another embodiment, the plurality of paddles are coupled to the shaft so as to be aligned along a generally helical path running along an operable portion of the shaft. In one specific embodiment, the plurality of paddles are interconnected by a solid web so as to form a continuous, generally spiraling surface. In another specific embodiment, the solid web interconnects paddles comprising first portions aligned with the generally spiraling surface, and second, distal portions angling away from the surface and toward the outlet end of the housing structure.

In yet another embodiment, the present invention is directed to an apparatus comprising a rotatable shaft having attached to it a spiral blade that continuously spirals around the shaft along an operable portion of its length. In particular embodiments, each flight of the spiral blade comprises one or more protrusions attached thereto on that side of the flight facing toward the outlet end of the housing structure, the protrusions extending radially from the shaft along a radius of the flight and protruding from the surface of the blade toward the outlet end of the housing structure (i.e., in the direction of conveyance of the foodstuffs), and having a leading edge. In a more specific embodiment, the cross section of the protrusions is substantially triangular or V-shaped.

Further embodiments are directed to apparatus comprising a rotatable shaft having a spiral blade attached thereto and protruding therefrom along a first longitudinal portion of the shaft, and a plurality of paddles attached thereto and protruding therefrom along a second longitudinal portion of the shaft.

The present invention is also directed to methods for treating surfaces of whole foodstuffs or parts thereof for the above-mentioned purposes. One embodiment discloses a method for treating whole foodstuffs or parts thereof comprising the steps of: introducing the foodstuffs into the inlet end of an apparatus, and applying, as a spray, an effective amount of a treatment fluid onto the surfaces of the foodstuffs, as the latter are being conveyed, while agitated and tumbled, from the inlet end to the outlet end of the apparatus, so as to improve the edibility, longevity, and/or appearance of the treated foodstuffs.

These and other aspects of the this invention will be evident upon reference to the following detailed description of the invention and accompanying drawings.

### BRIEF DESCRIPTION OF THE SEVERAL VIEWS OF THE DRAWING(S)

FIG. 1 illustrates a perspective view of a disinfectant/fungicide application apparatus for foodstuffs, in accordance with an embodiment of the present invention, having a rotatable shaft/paddle assembly.

FIG. 2 illustrates a side view of the disinfectant/fungicide application apparatus of FIG. 1.

FIG. 3 illustrates a perspective view of the disinfectant/fungicide application apparatus of FIG. 1.

FIG. 4 illustrates a top view of a disinfectant/fungicide application apparatus for foodstuffs, in accordance with another embodiment of the present invention.

FIG. 5 illustrates a perspective view of a rotatable shaft/spiral blade assembly for use in a disinfectant/fungicide application apparatus, in accordance with yet another embodiment of the present invention.

FIG. 6 illustrates perspective view of a rotatable shaft/spiral blade/paddle assembly for use in a disinfectant/fungicide application apparatus, in accordance with a further embodiment of the present invention.

FIG. 7 illustrates a plot of [initial bacteria count/final bacteria count] vs. log₁₀ reduction of the initial bacteria count to the final bacterial count.

FIG. 8 illustrates reductions of the total plate count (TPC) achieved when 90% lean beef parts (90/10's) are treated with the apparatus shown in FIG. 4.

FIG. 9 illustrates reductions of E. coli achieved when 90% lean beef parts (90/10's) are treated with the apparatus shown in FIG. 4.

FIG. 10 illustrates reductions of total plate counts (TPC's) achieved when 90% lean and 50% lean beef parts (90/10's and 50/50's) are treated using an apparatus of the present invention incorporating the rotatable shaft/spiral blade/paddle assembly shown in FIG. 6.

FIG. 11 illustrates reductions of E. coli achieved when 90% lean beef parts (90/10's) are treated using an apparatus of the present invention incorporating the rotatable shaft/spiral blade/paddle assembly shown in FIG. 6.

FIG. 12 illustrates reductions of the total plate count (TPC) achieved when 90% lean and 50% lean beef parts (90/10's and 50/50's) are treated using an apparatus of the present invention incorporating the rotatable shaft/spiral blade assembly, shown in FIG. 5.

FIG. 13 illustrates reductions of E. coli achieved when 90% lean and 50% lean beef parts (90/10's and 50/50's) are treated using an apparatus of the present invention having the rotatable shaft/spiral blade assembly shown in FIG. 5.

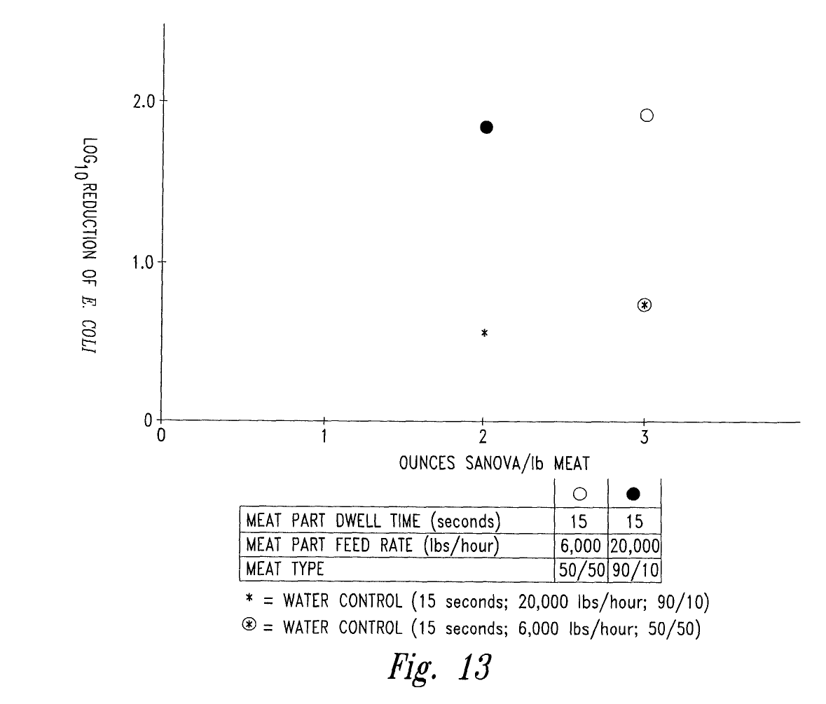

### DETAILED DESCRIPTION OF THE INVENTION

As noted above, the present invention is generally directed to methods and apparatus for use in applying treatment fluids to the surface of foodstuffs, in whole form or in parts thereof, for the purpose of improving their edibility, longevity, and/or appearance. As used herein, “treatment fluid” refers to, as some examples, a disinfectant, fungicide, flavoring agent (i.e., fluid comprising seasoning or spice), marinade, texturizer, tenderizer, or preservative, or mixtures thereof, where the treatment fluid may be in the form of a liquid or fluidizable solids. “Fluidizable solids” refers to a collection of solid particles that can be placed into a fluid-like motion and transported accordingly. “Disinfectant” means an agent adapted to kill or otherwise deactivate microbes such as viruses, bacteria, as well as nematodes and other parasitic organisms. “Fungicide” means an agent adapted to kill or otherwise deactivate fungi and moulds. Examples of disinfectants and fungicides are: acidified sodium chlorite solutions, aqueous chlorine dioxide solutions, quaternary ammonia compounds, per-acid solutions, hydrogen peroxide, organic acids, chlorine and chlorine compounds, metal hypohalites, electrolyzed water, ozone solutions, phenol and cresol compounds, iodine and iodine compounds, natural floral or faunal extracts, enzymatic products, surface-active agents, parabens, alcohols, solutions of heavy metals, chlorhexidine, peroxygen compounds, triazines, and aldehydes, among others.

Embodiments of the present invention may allow an effective quantity of a treatment fluid to be applied to substantially the entire surface of foodstuffs as the latter are conveyed from the inlet end to the outlet end of the inventive apparatus. Foodstuffs that may be so treated include: meat parts, seafood in whole form or in parts thereof, and fruits and vegetables in whole form or in parts thereof. As used herein, “meat” means fresh meat from animals of the red meat variety (e.g., beef, lamb, venison, etc.) or of the white meat variety (e.g., poultry, pork, etc.). Also, as used herein “seafood” means fish or shellfish. Typically, where treatment fluids are disinfectants, they are applied in spray form to the surfaces of meat, poultry, or seafood in an effective quantity, i.e., so as to substantially reduce or eliminate populations of bacteria found on the surfaces. Typically, disinfecting or fungicidal fluids are likewise applied to the surfaces of fruits and vegetables to substantially reduce or eliminate populations of bacteria or fungi found thereon. A number of specific details of certain embodiments of the invention are set forth in the following description and figures to provide a thorough understanding of such embodiments. One skilled in the art, however, will understand that the present invention may be practiced by way of additional embodiments or in the absence of some of the limitations set forth in the embodiments described below.

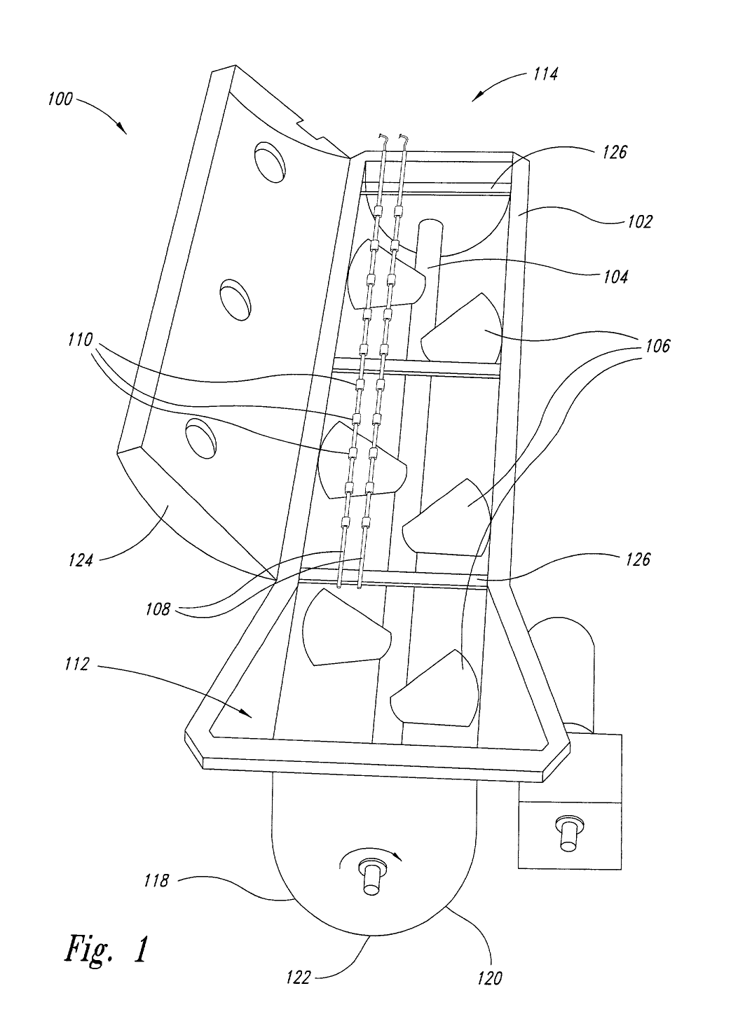

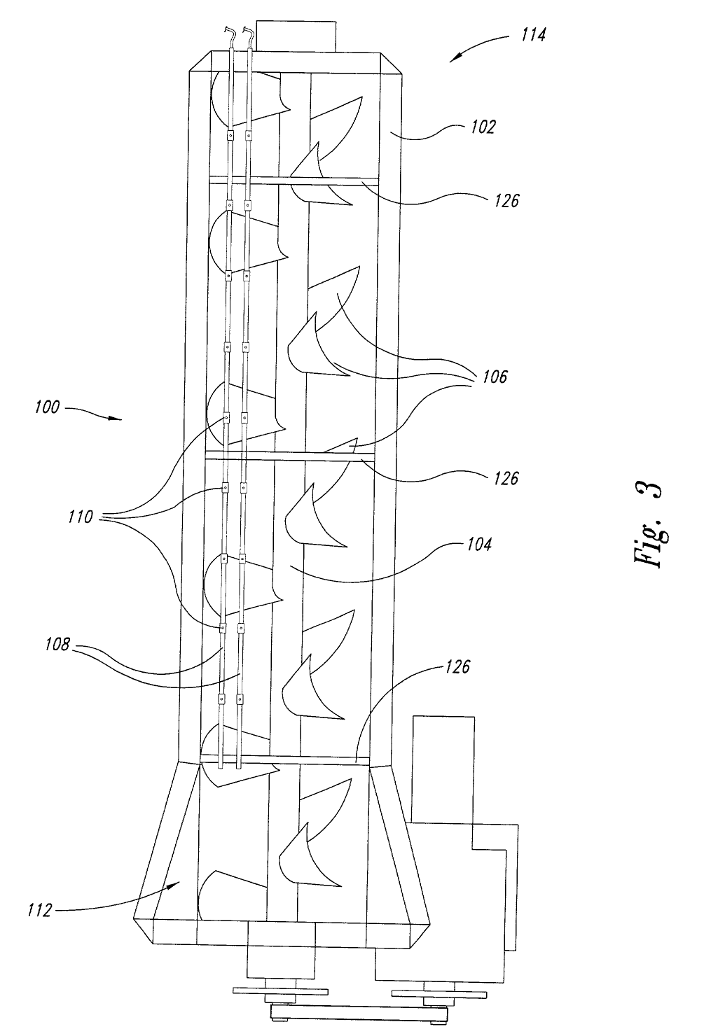

One embodiment is shown in FIGS. 1, 2, and 3, and described in detail below, as well as in Applicants' Provisional Application No. 60/240302, incorporated herein by reference in its entirety. In this embodiment, the present invention is directed to an apparatus 100 adapted to spray treatment fluids in liquid form to foodstuffs as the latter are conveyed, while agitated and tumbled. The apparatus includes a housing structure 102, a rotatable shaft 104 having a plurality of paddles 106 attached thereto along its length and protruding therefrom, and a fluid delivery system comprising two manifolds 108, each manifold being fitted with a plurality of spray nozzles 110. As shown in FIGS. 1, 2, and 3, the plurality of spray nozzles 110 are spaced along the manifolds 108 so as to deliver fluid from a point near an inlet end 112 to a point near an outlet end 114 of the housing structure 102. As shown in FIGS. 1 and 3, the two manifolds 108 are supported by three spreader bars 126 above the opening to the housing structure 102. The two manifolds 108 are shown closer to a left side-wall 118 than to a right side-wall 120. However, different embodiments are contemplated that may have only one manifold or more than two manifolds, fitted with a greater or lesser number of nozzles, and located above or below the opening to a housing structure. Also, the manifolds may be differently spaced, in the latitudinal direction, with respect to a housing structure.

As shown in FIG. 1, the latitudinal cross-section of the housing structure is substantially U-shaped, the U-shape being formed from the substantially planar left sidewall 118, substantially planar right side-wall 120, and semi-circular bottom portion 122 of the housing structure 102. The semi-circular bottom portion 122 has a diameter such that the gap between the distal ends of the plurality of paddles 106 and the semi-circular bottom portion 122 is substantially less than the smallest dimension of a treated foodstuff part. A gap distance of about 3/16″ is one example. Also shown is a lid 124, hingedly connected to the housing structure 102. The lid 124 is adapted to be closed, thereby encasing the shaft 104, plurality of paddles 106, and manifolds 108 in an enclosed housing structure. In other embodiments, the lid need not be hingedly or otherwise connected to the housing structure when not covering its opening.

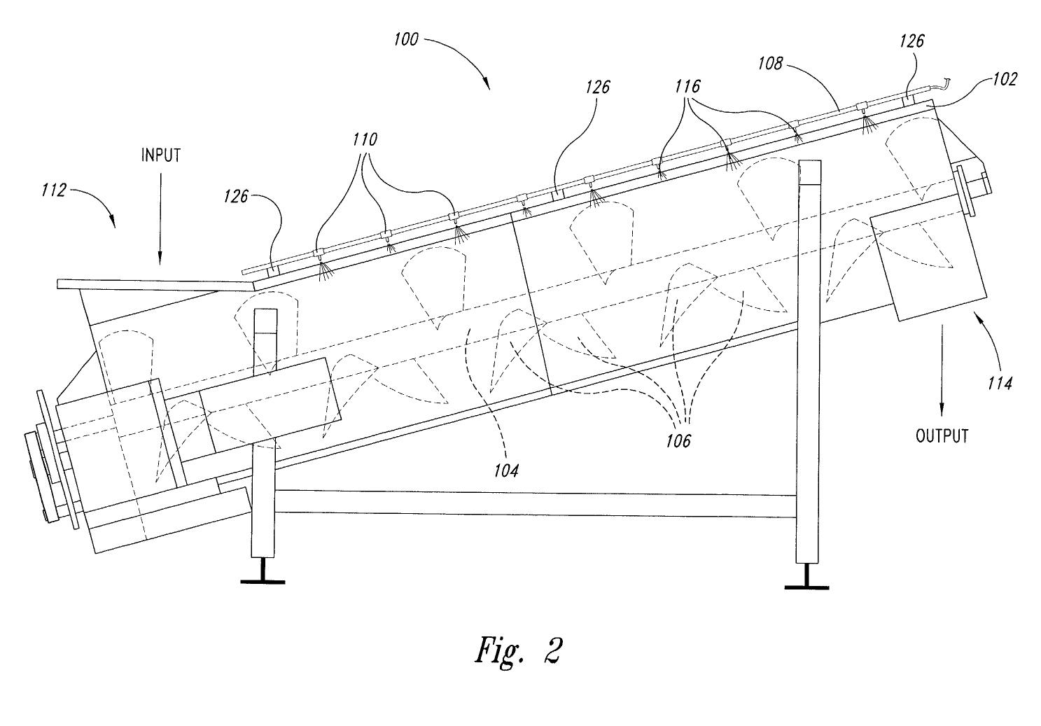

As shown most clearly in FIG. 2, the rotatable shaft 104 having the plurality of paddles 106 attached thereto and protruding therefrom resides within the housing structure and is adapted to move foodstuffs (not shown) from the inlet end 112 to the outlet end 114 during processing. The rotatable shaft 104 has a round latitudinal cross-section and is, therefore, cylindrical. However, other latitudinal cross-sections are contemplated for the rotatable shafts comprised in embodiments of this invention. In all cases, the length of the shaft is much greater than its diameter. The rotational motion of the shaft is typically imparted to it by an electric motor coupled to the shaft by a transmission means. The plurality of paddles 106 are shown to be generally fan blade-shaped. However, other embodiments are contemplated where the paddles comprised therein are not fan blade-shaped.

The rotational motion of the shaft and paddles, combined with the geometry of the paddles, imparts both a translational and rotational motion to the foodstuffs, thus conveying the latter along a generally spiral path from the inlet end 112 to the outlet end 114. The foodstuffs depart from such a path to the extent that gravity causes them to tumble downward, and to the extent that both gravity and the close proximity of discrete foodstuff parts creates agitation. Hence, the foodstuffs are described as being conveyed, while agitated and tumbled.

The fluid delivery system, as shown in FIGS. 1-3, is adapted to apply a liquid treatment fluid, as a spray 116 emitted from the plurality of spray nozzles 110, to the surface of the foodstuffs as the latter are conveyed, while agitated and tumbled, from the inlet end 112 to the outlet end 114 of the housing structure 102. In one specific embodiment, the plurality of spray nozzles 110 may be configured to deliver a spray in the form of a fog or mist. In another specific embodiment, the plurality of spray nozzles 110 may be configured to deliver a full cone-shaped spray. In another specific embodiment, a fan-shaped spray may be delivered. In yet another specific embodiment, for a given apparatus, some of the spray nozzles 110 may deliver a spray as a fog or mist, some may deliver a full cone-shaped spray, and some a fan-shaped spray. Also, in one embodiment of this invention, all of the plurality of spray nozzles 110 deliver about the same flow rate of disinfecting or fungicidal fluid, while in another embodiment, the spray nozzles located closer to the inlet end 112 deliver a higher flow rate of fluid than that delivered by the spray nozzles located closer to the outlet end 114. The latter embodiment may be used where it is desirable to reduce the amount of disinfectant or fungicide adhering to surfaces of foodstuffs after treatment.

In yet another embodiment, an apparatus comprises a fluid delivery system adapted to apply different types of treatment fluids to a particular foodstuff sample as the latter is conveyed from the inlet to the outlet of the apparatus. The different types of treatment fluids may be applied sequentially or simultaneously. As one example, for embodiments where the fluid delivery system has one or more manifolds, the fluid delivery system may apply one type of treatment fluid as the foodstuffs are initially conveyed away from the inlet. Then, by means of a switching valve or similar device, another type of treatment fluid may be delivered to the manifold(s) and applied to the foodstuffs as the latter are further conveyed toward the outlet. As another example, for embodiments where the fluid delivery system has two manifolds, as foodstuffs are conveyed from the inlet to the outlet of the apparatus, one type of treatment fluid is delivered to one manifold and applied to the foodstuffs, and, at the same time, a different type of treatment fluid is delivered to the other manifold and applied to the foodstuffs.

Other embodiments are directed to apparatus with a fluid delivery system adapted to apply fluids that are fluidizable solids, rather than liquids. Examples of such fluidizable solids are disinfectants, fungicides, seasonings, and preservatives in the form of a powder. Any individual having an ordinary level of skill in the art would appreciate that fluid delivery systems having manifolds and nozzles such as is shown in FIGS. 1-3, would not be effective for application of such fluidizable solids, and that the fluid delivery system would have to be modified as needed to use, for example, a sifter or other type of conveyance and delivery means suitable for fluidizable solids.

The above suggests additional embodiments directed to apparatus having fluid delivery systems comprising a combination of the above-described fluid delivery and application elements and, thereby, adapted to apply both liquid and fluidizable solid treatment fluids to a particular foodstuff sample, either sequentially or simultaneously.

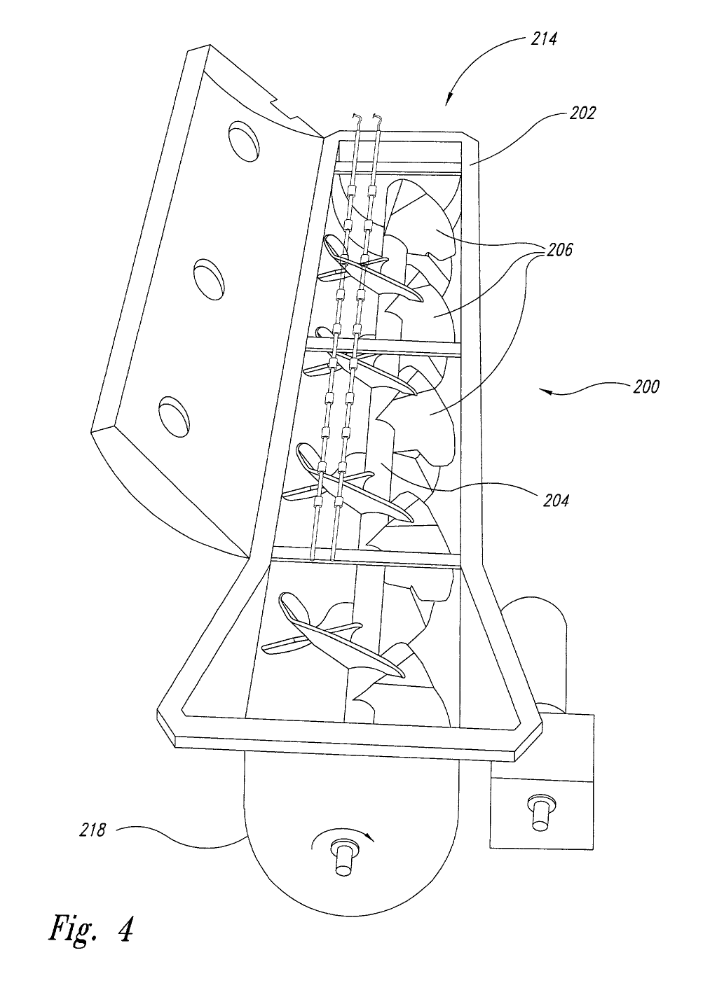

In another embodiment, the otherwise generally fan blade-shaped paddles each have a distal end bent toward the outlet end of a housing structure. FIG. 4 illustrates a more specific embodiment wherein an apparatus 200 comprises a rotatable shaft 204 having attached thereto and protruding therefrom a plurality of paddles 206, each having a bent distal end, the latter being bent toward an outlet end 214 of a housing structure 202 and comprising a first bend and a second bend. It has been surprisingly discovered that these bends enhance the tendency of treated foodstuffs, at least where the foodstuffs are meat parts, to accumulate toward a left side-wall 218 when the rotatable shaft 204 and plurality of paddles 206 rotate in a clockwise fashion (as viewed from an inlet end 212 toward an outlet end 214). The fluid delivery system may thus comprise first and second manifolds 208, the first manifold located generally above the rotatable shaft 204, and the second manifold located between the first manifold and the left side-wall 218. In other embodiments, the manifolds may also be located closer to one of the side-walls. However, in yet other embodiments, the manifolds may be positioned differently. For example, a first manifold may be positioned near a left side-wall, while a second manifold is positioned closer to a right side-wall.

In yet another embodiment, the apparatus of the present invention incorporates a conveyance assembly comprising a plurality of paddles that are attached to a rotatable shaft along a generally helical path and that are aligned with a spiral plane projecting outwardly from the helical path. In one embodiment, the paddles are interconnected by a solid web also aligned with the spiral plane and attached to the shaft. Thus, there is formed a continuous, generally spiraling surface along an operable portion of the shaft, where there are essentially no gaps between the shaft and the interconnected paddles. In a more specific embodiment, a conveyance assembly includes a rotatable shaft and a plurality of paddles interconnected as described above by a solid web, wherein each of the plurality of paddles is a curved blade having a first portion in substantial alignment with the generally spiral surface, and a second distal portion forming angled distal surfaces angling away from the generally spiral surface and toward the outlet end of a housing structure. Such a conveyance assembly can be adapted for use in apparatus such as those shown in FIGS. 1-4 as an alternative to the shaft and paddle conveyance assemblies shown therein.

A further embodiment is directed to an apparatus such as that shown in FIGS. 1-3 or 4, but incorporating a conveyance assembly comprising a rotatable shaft having attached thereto and protruding therefrom, a spiral blade, rather than a plurality of paddles. The spiral blade continuously spirals around the rotatable shaft along an operable portion of its length, each 360° of traverse along the edge of the blade corresponding to one flight of the blade. In yet a further embodiment, each flight of the spiral blade comprises one or more protrusions attached thereto. Each protrusion continuously extends radially from the rotatable shaft, protrudes from the surface of the spiral blade toward an outlet end of a housing structure, and has a leading edge. In specific embodiments, the number of protrusions comprised on each flight of the spiral blade is 1, 2, 3, 4, or more than 4, respectively. For some embodiments, where there is a plurality of protrusions comprised in a flight, the protrusions are spaced apart with substantially equal spacing. For other embodiments, where there is a plurality of protrusions comprised in a flight, the protrusions are spaced apart with substantially unequal spacing.

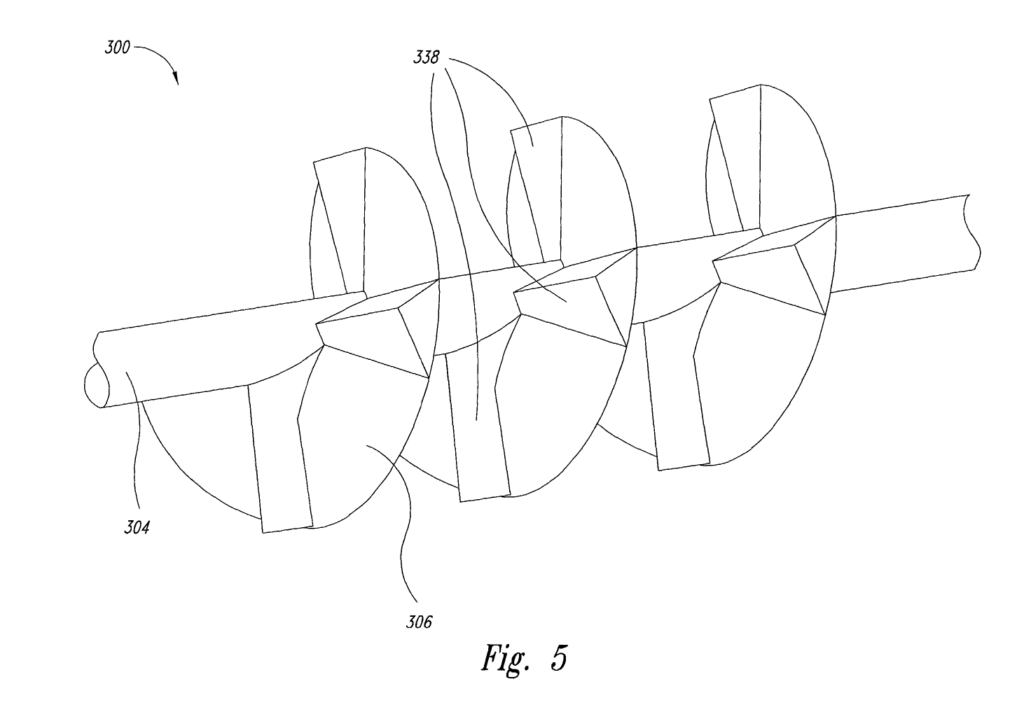

FIG. 5 illustrates a conveyance assembly 300 comprising a rotatable shaft 304 having attached thereto a spiral blade 306. As shown, each flight 336 of the spiral blade 306 has attached thereto four protrusions 338. The protrusions 338 are shown equally spaced apart (i.e., 90° from one protrusion to the next). Also as shown, each of the protrusions 338 is substantially V-shaped. As an example, the protrusions may be formed by welding 3″ angle-iron to the flights of the spiral blade. Or, the protrusions may be integrally formed with the blade. The conveyance assembly 300 shown in FIG. 5 can be adapted for use in apparatus such as those shown in FIGS. 1-4 as an alternative to the shaft and paddle assemblies shown therein.

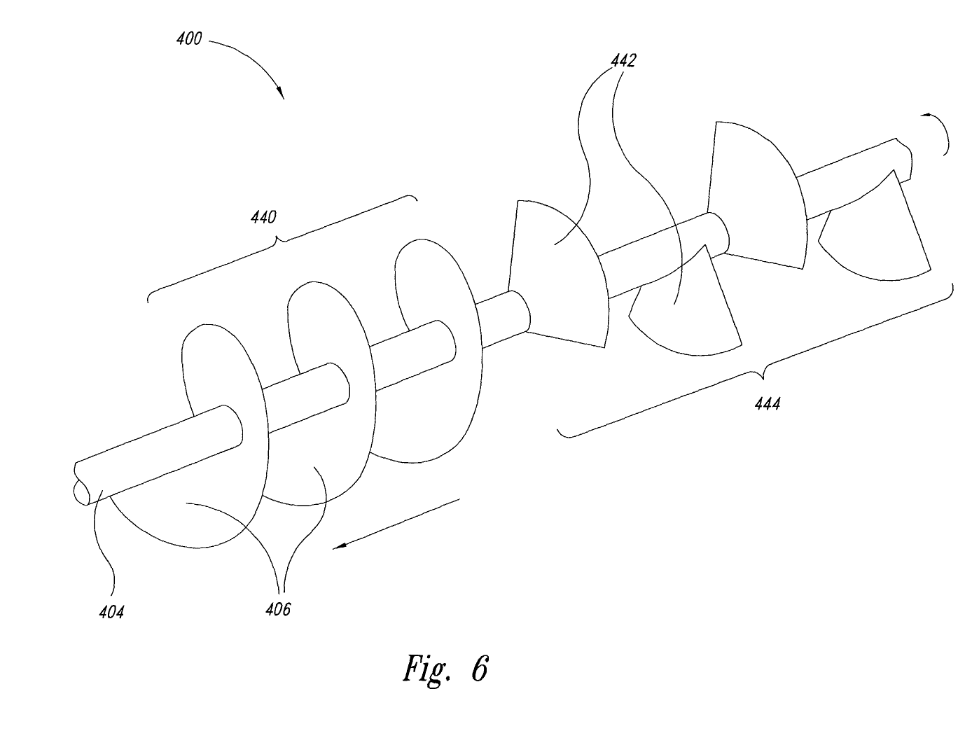

FIG. 6 illustrates an assembly 400, comprised in another embodiment of the present invention, wherein the assembly includes a rotatable shaft 404 having attached thereto a spiral blade 406 along a first longitudinal portion 440 of the shaft 404, and a plurality of generally fan blade-shaped paddles 442 attached thereto along a second longitudinal portion 444 of the shaft. In operation, as indicated in FIG. 6, the portion of the rotatable shaft 404 having the spiral blade 406 attached thereto is that portion closest to the inlet end 412 of the apparatus 400. In related embodiments, the spiral blade may have one or more protrusions attached thereto, as described above, and/or each of the plurality of paddles may have a bent distal end comprising one or more bends, as described above.

For embodiments of the present invention directed to apparatus, the housing structure; the rotatable shaft; the plurality of paddles; the spiral blade; the solid web interconnecting the plurality of paddles; and the protrusions comprised in the spiral blade, are preferably made of metal, and, most preferably of stainless steel. Also, for the illustrated embodiments directed to apparatus, the rotatable shaft with the plurality of paddles and/or spiral blade attached thereto, is adapted to convey and tumble foodstuffs from the inlet end to the outlet end of the inventive apparatus when the shaft rotates in a clockwise fashion (as viewed from the inlet end toward the outlet end). One of ordinary skill in the art, however, would appreciate that other materials would be suitable, and that the apparatus could be configured to operate through counter-clockwise rotation.

The inlet end of the apparatus may be level with respect to the outlet end, or the inlet end may be elevated in relation to the outlet end, or the outlet end may be elevated in relation to the inlet end. For example, FIG. 1 shows the outlet end 114 elevated in relation to the inlet end 112. In specific embodiments, the outlet end is elevated in relation to the inlet end to an extent such that the rotatable shaft is at an angle of about 10° to about 20° from the horizontal, or at an angle of about 15° from the horizontal, respectively. So that such angles of elevation may be readily realized, the housing structure can be mounted on adjustable legs.

There may be advantages to having the outlet end elevated in relation to the inlet end of the housing structure of the present invention. Such a configuration may expedite conveying foodstuffs from one piece of equipment to another in a processing plant. Also, it has been observed that, in some cases, foodstuffs are flipped more when conveyed from an inlet end to an elevated outlet end, as compared to being conveyed horizontally. The result may be better surface coverage by the applied disinfectant or fungicide. Finally, when the outlet end is elevated in relation to the inlet end, a reservoir of disinfecting or fungicidal fluid may optionally be maintained at the inlet end of the housing structure and used to initially immerse the foodstuffs entering the housing structure before they are then conveyed toward the outlet end while being sprayed with additional disinfecting or fungicidal fluid. Accordingly, the housing structure of the embodiments of the present invention may comprise a drain near the inlet end, wherein the drain is opened when no reservoir of fluid is desired and closed when a reservoir is desired.

For some embodiments directed to apparatus having a conveyance assembly that comprises a generally spiral blade, it has been observed that, between flights of the blade, foodstuff pieces tend to cluster and, thereby retain treatment fluid (when in liquid form) as small pools, even when the outlet end of the housing structure is elevated in relation to the inlet end. The clustering results in an agitated motion of the foodstuff parts in the pool of treatment fluid, and apparently effective contact of all foodstuff surfaces with the treatment fluid. Applicant thereby appreciates that effective contact between foodstuff surfaces and treatment fluid may not, in some cases, require application of treatment fluid as an overhead spray. Instead, it may suffice to cause the treatment fluid to enter the housing structure through its sidewalls as a spray or streams, or to enter the housing structure by pooling up from its bottom portion.

In further embodiments, methods for applying treatment fluids to surfaces of foodstuffs are disclosed. One embodiment is directed to a method that comprises the steps of: introducing foodstuffs into the inlet end of an apparatus, and applying, as a spray, an effective amount of a treatment fluid to the surfaces of the foodstuffs as the latter are conveyed, while agitated and tumbled, from the inlet end to the outlet end of the apparatus. More specifically, foodstuffs, such as meat parts, or such as seafood, vegetables, or fruits, in whole form or in parts thereof, are introduced into the inlet end of the housing structure of an apparatus of the present invention. In one specific embodiment, the foodstuffs are briefly immersed in a reservoir of a treatment fluid, the reservoir being a pool of treatment fluid at the inlet end of the housing structure made possible by having the outlet end elevated in relation to the inlet end. In another embodiment, there is no reservoir of treatment fluid at the inlet end of the housing structure. In either embodiment, after the foodstuffs are introduced into the inlet end, they are conveyed, while agitated and tumbled, toward the outlet end by a rotatable shaft having a plurality of paddles and/or a spiral blade attached thereto as the shaft rotates.

In some embodiments, while the foodstuffs are being conveyed, they are sprayed with a treatment fluid delivered from a plurality of overhead spray nozzles. Surface coverage by the treatment fluid is achieved by direct contact between the foodstuff surfaces and sprayed fluid; by contact between the foodstuff surfaces and other foodstuff surfaces having sprayed fluid contained thereon; by contact between the foodstuff surfaces and pooled treatment fluid; and by contact between the foodstuff surfaces and various apparatus surfaces (e.g., housing structure, rotatable shaft, paddles and/or helically-shaped blades, etc.) having sprayed treatment fluid contained thereon. As a specific example, the treatment fluid is a disinfecting fluid that is an aqueous solution containing from about 0.001% to about 0.2% by weight of a metal (such as sodium or potassium) chlorite and an amount of an acid sufficient to adjust the pH of the solution to from about 2 to about 5, preferably from about 2.2 to about 4.5, to maintain the chlorite ion concentration in the form of chlorous acid to not more than about 35% by weight of the total amount of chlorite ion concentration in the solution, and to minimize chlorine dioxide generation. Such disinfectant solutions have been disclosed in U.S. Pat. No. 5,389,390, which is incorporated herein by reference in its entirety.

Again, Applicant appreciates that the step of applying a treatment fluid may be accomplished in other ways. Where the treatment fluid is a liquid, it may also be introduced through the sidewalls of the housing structure as either a spray or streams. Or, it may be introduced through the bottom of the housing structure so as to pool up from the bottom. Effective coverage of foodstuff surfaces is then achieved by the mechanisms for mass transfer described in the preceding paragraph. Where the treatment fluid is a fluidizable solid, it may be applied as such under pressure or may be applied using a fluid delivery system incorporating a sifter or other such device.

The following examples are provided for the sole purpose of illustrating the effectiveness of the inventive apparatus and methods described herein as applied to foodstuffs that are meat parts and using a treatment fluid that is a disinfectant. Accordingly, the following examples are not to be construed as limiting the scope of the present invention.

### EXAMPLES

The examples given below set forth the results of tests that were conducted by Applicant to determine the effectiveness of apparatus typifying the apparatus disclosed above when used in conjunction with a disinfectant commercially available from the Alcide Corporation (Redmond, Wash.) and applied to foodstuffs consisting of fresh meat parts. The disinfecting fluid, designated SANOVA®, is an aqueous solution of acidified sodium chlorite (AS C) comprising 1000 ppm sodium chlorite and 6000 ppm citric acid, the acid adjusting the pH of the solution to 2.5.

Two types of meat parts were used for the examples below. The first type, designated as “90/10's”, are beef parts that are 90% red meat and 10% fat. The parts were obtained from a packing facility in 60 pound boxes and, after being cut, consisted of pieces ranging in weight from 6 ounces to 10 pounds and in size from 2″×1″×4″ to 14″×3″×30″. The second type, designated as “50/50's”, are beef parts that are 50% red meat and 50% fat. The parts were obtained in bulk form from a slaughtering facility and consisted of pieces ranging in weight from 1 ounce to 10 pounds and in size from ½″×½″×½″ to 8″×3″×18″. All of the meat used for the tests was less than 48 hours old.

Three different shafts were used for the treatments reported in the examples. The rotatable shaft designated as “Shaft 1” is a cylindrical shaft, 4 inches in diameter and 10 feet in length, with a plurality of paddles attached to it, each paddle having a bent distal end with a first bend and a second bend (see, e.g., FIG. 3). The rotatable shaft designated as “Shaft 2” is a cylindrical shaft, 4 inches in diameter and 10 feet in length, and having a helically-shaped blade attached to it from its end closest to the inlet of the housing structure to a point 29 inches from that end (corresponding to the location of first nozzles), and a plurality of paddles (similar to those used for Shaft 1) attached to it along the rest of its length (see, e.g., FIG. 6). The rotatable shaft designated as “Shaft 3” is a cylindrical shaft, 4 inches in diameter and 10 feet in length, with a helically-shaped blade attached to it along its entire length. Each flight of the blade has four protrusions welded to it and formed from 3 inch stainless steel “angle-iron” (see, e.g., FIG. 5). Shafts 1, 2, and 3 have an overall diameter of 2 feet and are constructed of stainless steel—as is the housing structure. The gap between the paddles or helically-shaped blade and the rounded bottom portion of the housing structure was about 3/16 inch. The fluid delivery system used for the treatments reported below used two manifolds constructed of ⅝ inch stainless steel tubing. One manifold was positioned 4 inches from the left side-wall of the housing structure, and the other manifold was positioned 6 inches to the right of it. Seven nozzles per manifold were used and delivered a full, cone-shaped spray. Unless otherwise indicated, tests were conducted with the outlet end of the housing structure elevated relative to the inlet end such that the rotatable shaft is at an angle of about 15 degrees from the horizontal.

Two different meat part feed rates were used. For some tests, 60 pounds of meat were fed into the apparatus during a period of 36 seconds, yielding a feed rate of about 6,000 pounds per hour. For other tests, 60 pounds of meat parts were fed into the apparatus during a period of 10 seconds, yielding a feed rate of about 20,000 pounds per hour. The disinfectant fluid was delivered at three rates: 1, 2, or 3 ounces per pound of meat parts treated. Three dwell times (i.e., time during which the meat was sprayed with the disinfectant fluid as it traveled through the apparatus) were used for the meat parts: 5, 10, and 15 seconds. Three types of bacterial counts were measured: total naturally-occurring bacteria, E. coli, and total coliforms. Water control tests were also conducted where water, instead of disinfectant, was sprayed onto the meat parts.

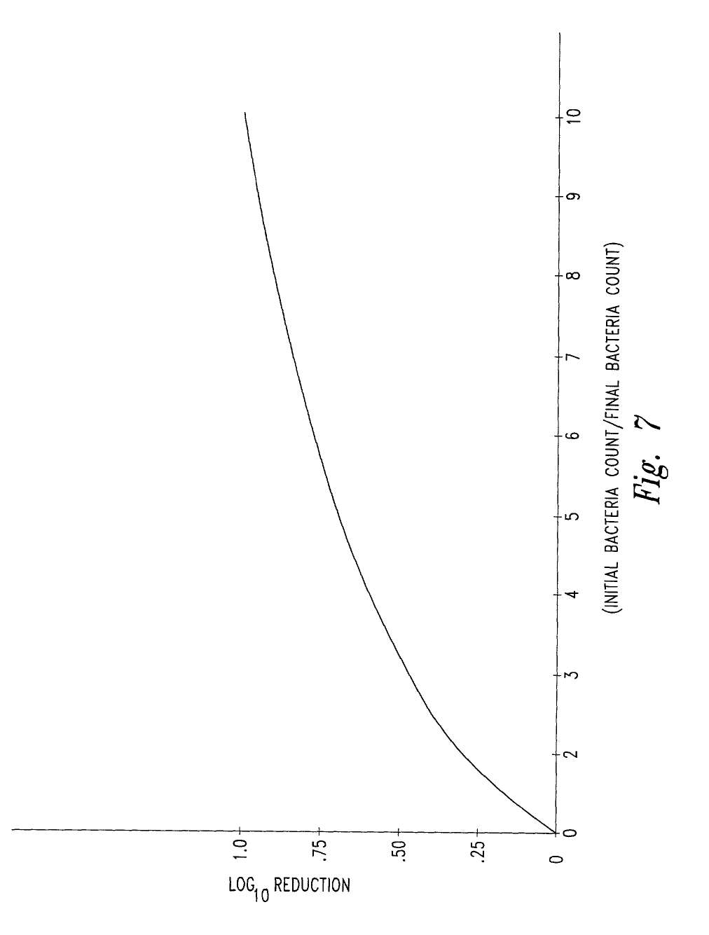

Reported in the examples below are log₁₀ reductions of surface bacterial populations as a function of the rate of disinfectant fluid delivery. This functional relationship is presented for the different rotatable shafts used, meat part feed rates used, bacteria measured, and meat part dwell times. The log₁₀ reduction of a bacterial population is simply the log₁₀ of the final population subtracted from the log₁₀ of the initial population. (Note: populations are measured and expressed in terms of colony forming units per square centimeter, or cfu/cm²). Expressed differently, the log₁₀ reduction is equal to log₁₀ [initial population/final population]. As an example, a tenfold reduction in a bacterial population translates to a log₁₀ reduction of that population of 1. A plot of [initial bacterial count/final bacterial count] vs. the corresponding log₁₀ reduction is shown in FIG. 7 for ease in translating one number into the other.

For some tests, the reduction in the total surface bacterial contamination, naturally found on the meat parts, was measured. Such contamination is designated as the total plate count (TPC) or, alternatively, as the aerobic plate count (APC). The contamination was measured on three meat parts before treatment and three different (i.e., not previously handled) parts after treatment. For other tests, three meat parts were tagged and artificially contaminated using an inoculum solution containing five strains of nonpathogenic E. coli (ATCC 15597, ATCC 12435, ATCC 8677, ATCC 14998, and ATCC 35270). The meat parts were immersed in about 8 liters of the inoculum for 30 seconds per side and then allowed to drain for one hour at 4° C. to effect microbial attachment. To measure the E. coli populations before and after treatment, sterile sampling sponges were used that were hydrated with about 15 mL of sterile Butterfield's Phosphate Buffer to which 0.1% of sodium thiosulfate had been added.

The log₁₀ reductions reported below are geometric means, calculated from averaging measurements of surface contamination made using three tagged meat parts, the measurements taken at 10 locations on each part, and the measurements made for either two or three repeat test treatments per set of parameters.

### Example 1

### Uninoculated Meat Parts Treated Using Shaft 1

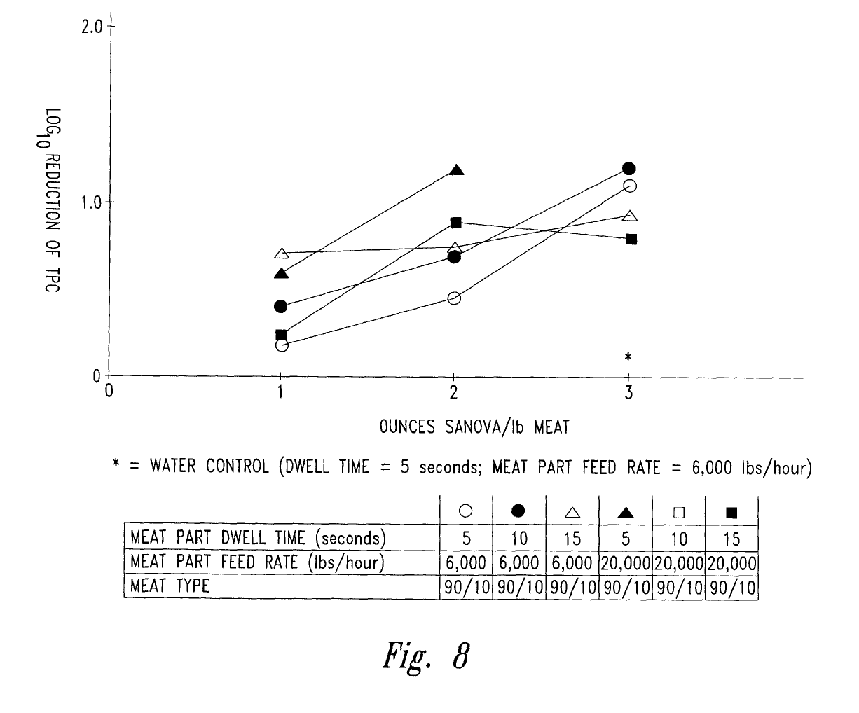

This example illustrates the effectiveness of using an apparatus of this invention, with Shaft 1 installed, to treat naturally-occurring bacteria attached to the surface of meat parts. The meat parts treated were 90/10's. Bacterial populations were measured before and after treatment. Log₁₀ reductions of the bacteria counts were determined as a function of the quantity of SANOVA® disinfectant used per pound of meat parts treated. Tests were conducted for meat part feed rates of 6,000 pounds per hour, with meat part dwell times of 5, 10, and 15 seconds; and 20,000 pounds per hour, with meat part dwell times of 5 and 15 seconds. The results are shown in FIG. 8 as plots of log₁₀ reduction of bacteria vs. quantity of disinfectant used.

### Example 2

### Inoculated Meat Parts Treated Using Shaft 1

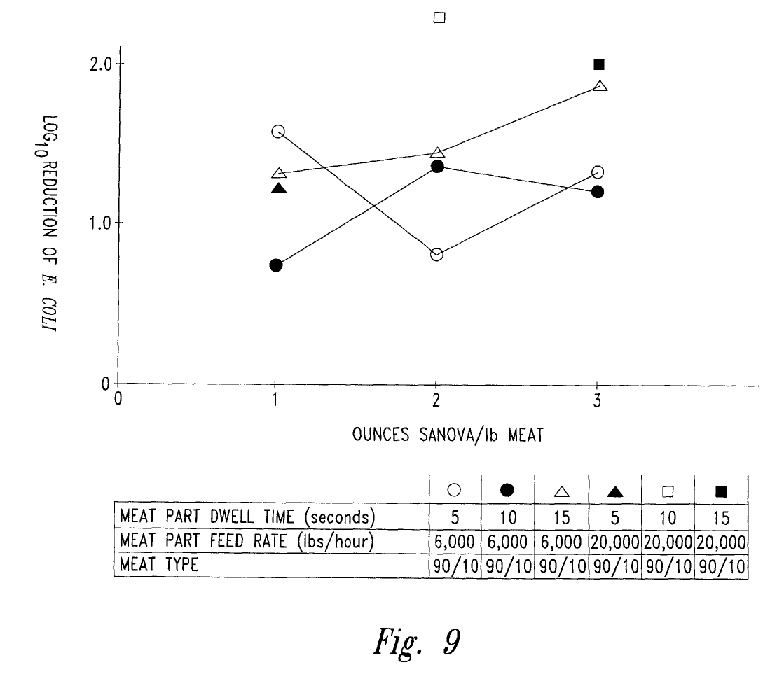

This example illustrates the effectiveness of using an apparatus of this invention, with Shaft 1 installed, to treat E. coli artificially attached to the surface of meat parts via inoculation. The meat parts treated were 90/10's. Bacterial populations were measured before and after treatment. Log₁₀ reductions of the bacteria counts were determined as a function of the quantity of SANOVA® disinfectant used per pound of meat parts treated. Tests were conducted for meat part feed rates of 6,000 pounds per hour, with meat part dwell times of 5, 10, and 15 seconds; and 20,000 pounds per hour, with meat part dwell times of 5, 10, and 15 seconds. The results are shown in FIG. 9 as plots of log₁₀ reductions of bacteria vs. quantity of disinfectant used.

### Example 3

### Uninoculated Meat Parts Treated Using Shaft 2

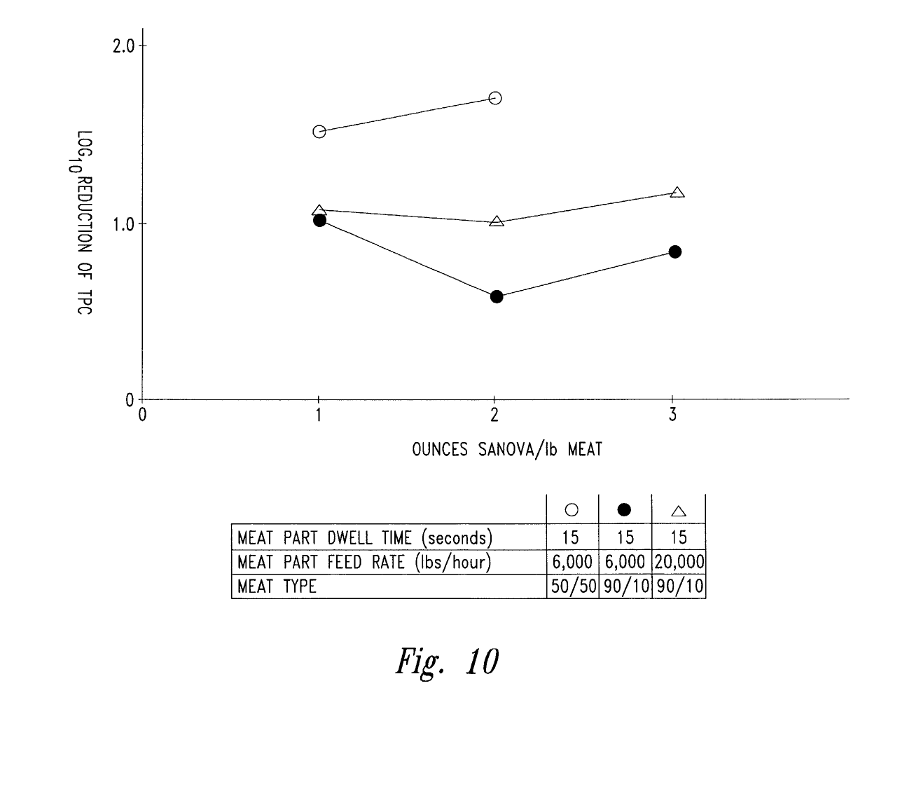

This example illustrates the effectiveness of using an apparatus of this invention, with Shaft 2 installed, to treat naturally-occurring bacteria attached to the surface of meat parts. The meat parts treated were 90/10's and 50/50's. Bacterial populations were measured before and after treatment. Log₁₀ reductions of the bacteria counts were determined as a function of the quantity of SANOVA® disinfectant used per pound of meat parts treated. Tests were conducted for meat part feed rates of 6,000 pounds per hour, with a meat part dwell time of 15 seconds, for 50/50's; 6,000 pounds per hour with a meat part dwell time of 15 seconds for 90/10's; and 20,000 pounds per hour with a meat part dwell time of 5 seconds, for 90/10's. The results are shown in FIG. 10 as plots of log₁₀ reductions of bacteria vs. quantity of disinfectant used.

### Example 4

### Inoculated Meat Parts Treated Using Shaft 2

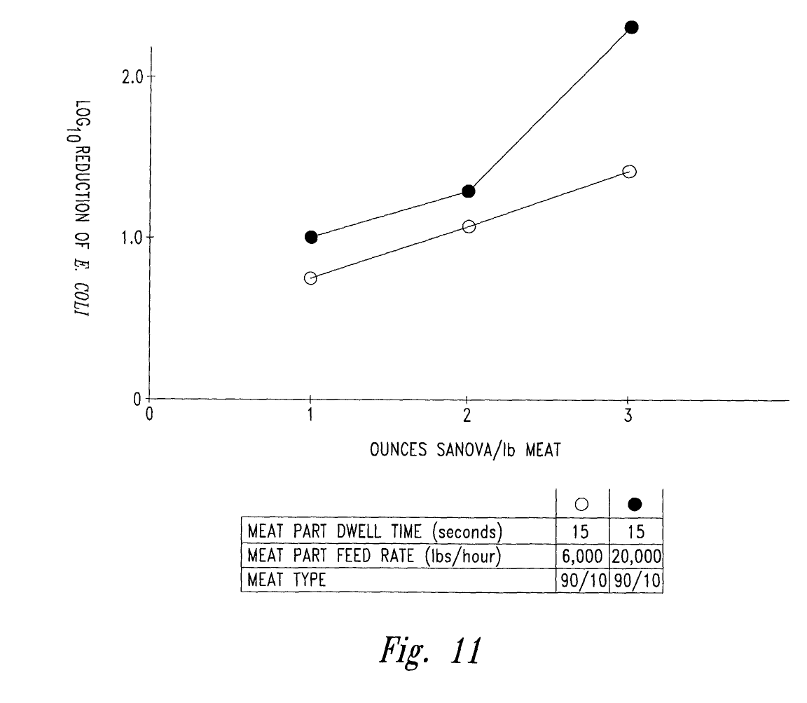

This example illustrates the effectiveness of using an apparatus of this invention, with Shaft 2 installed, to treat E. coli artificially attached to the surface of meat parts via inoculation. The meat parts treated were 90/10's. Bacterial populations were measured before and after treatment. Log₁₀ reductions of the bacteria counts were determined as a function of the quantity of SANOVA® disinfectant used per pound of meat parts treated. Tests were conducted for meat part feed rates of 6,000 pounds per hour, with a meat part dwell time of 5 seconds; and 20,000 pounds per hour, with a meat part dwell time of 15 seconds. The results are shown in FIG. 11 as plots of log₁₀ reductions of bacteria vs. quantity of disinfectant used.

### Example 5

### Uninoculated Meat Parts Treated Using Shaft 3

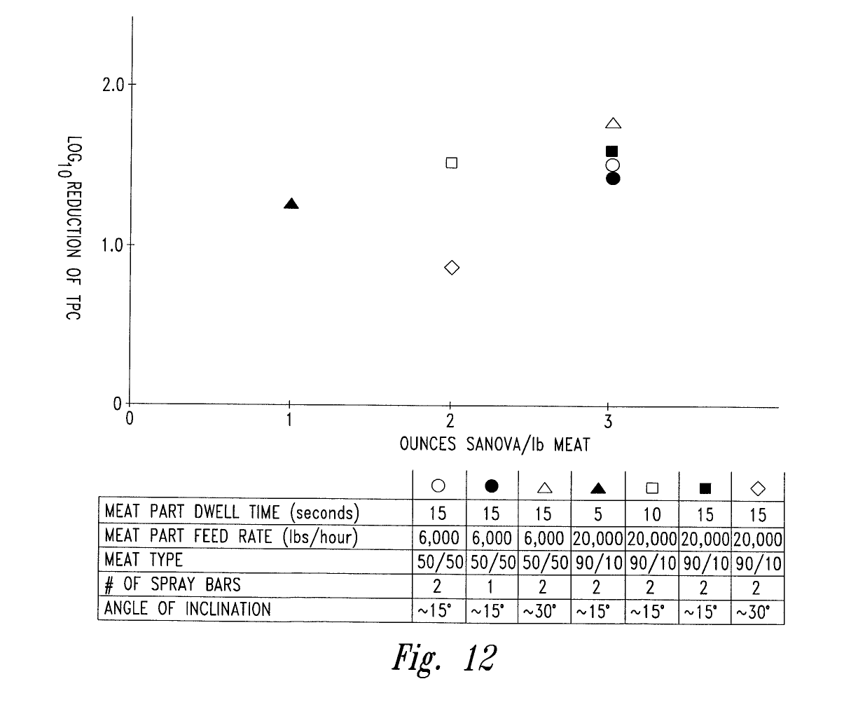

This example illustrates the effectiveness of using an apparatus of this invention, with Shaft 3 installed, to treat naturally-occurring bacteria attached to the surface of meat parts. The meat parts treated were 90/10's and 50/50's. Bacterial populations were measured before and after treatment. Log₁₀ reductions of the bacteria counts were determined as a function of the quantity of SANOVA® disinfectant used per pound of meat parts treated. Tests were conducted for meat part feed rates of 6,000 pounds per hour, with a meat part dwell time of 15 seconds, for 50/50's; 6,000 pounds per hour with a meat part dwell time of 15 seconds for 90/10's; and 20,000 pounds per hour, with meat part dwell times of 5, 10, and 15 seconds, for 90/10's. The results are shown in FIG. 12 as plots of log₁₀ reductions of bacteria vs. quantity of disinfectant used.

### Example 6

### Inoculated Meat Parts Treated Using Shaft 3

This example illustrates the effectiveness of using an apparatus of this invention, with Shaft 3 installed, to treat E. coli artificially attached to the surface of meat parts via inoculation. The meat parts treated were 90/10's and 50/50's. Bacterial populations were measured before and after treatment. Log₁₀ reductions of bacteria counts were determined after applying either SANOVA® or water to the meat parts. When 50/50's were treated using a feed rate of 6,000 pounds per hour, a disinfectant fluid delivery rate of 3 ounces per pound of meat treated, and a meat part dwell time of 15 seconds, the log₁₀ reduction of E. coli was 1.9306. When water was applied to the meat parts, rather than disinfectant, but, otherwise, using the same parameters, the log₁₀ reduction was 0.7301. When 90/10's were treated using a feed rate of 20,000 pounds per hour, a disinfectant fluid delivery rate of 2 ounces per pound of meat treated, and a meat part dwell time of 15 seconds, the log₁₀ reduction of E. coli was 1.8595. When water was applied to the meat parts, rather than disinfectant, but, otherwise using the same parameters, the log₁₀ reduction was 0.5620.

From the foregoing, it will be appreciated that all of the specific embodiments and examples described above have been presented for purposes of illustration, and that various modifications may be made without deviating from the spirit and scope of the invention. Accordingly, the present invention is not limited except insofar as it is by the appended claims.

1. An apparatus comprising:
an elongated housing structure extending from an inlet end to an outlet end along a longitudinal axis;
a shaft rotatably engaged with the housing structure to rotate about the longitudinal axis;
a plurality of paddles coupled to and protruding from the shaft, the paddles being adapted to rotatably convey and tumble foodstuffs from the inlet end to the outlet end of the housing structure; and
a fluid delivery system adapted to apply a treatment fluid to the foodstuffs as they are conveyed, while agitated and tumbled, from the inlet end to the outlet end.

2. The apparatus of claim 1 wherein each of the plurality of paddles is generally fan blade-shaped.

3. The apparatus of claim 2 wherein each of the plurality of fan blade-shaped paddles has a bent distal end, the distal end being bent generally toward the outlet end of the housing structure.

4. The apparatus of claim 3 wherein the bent distal end of each of the plurality of generally fan blade-shaped paddles comprises a first bend and a second bend.

5. The apparatus of claim 1 wherein the housing structure, the shaft, and the plurality of paddles are made of metal.

6. The apparatus of claim 5 wherein the metal is stainless steel.

7. The apparatus of claim 1 wherein the shaft is substantially cylindrical.

8. The apparatus of claim 1 wherein the fluid delivery system is adapted to apply more than one type of treatment fluid in a sequential fashion to a foodstuff sample as it is conveyed from the inlet end to the outlet end.

9. The apparatus of claim 1 wherein the fluid delivery system is adapted to apply more than one type of treatment fluid at the same time.

10. The apparatus of claim 1 wherein the fluid delivery system comprises at least one manifold, and wherein the at least one manifold is substantially parallel to the shaft, is fitted with a plurality of spray nozzles, is situated near an opening along the top of the housing structure, and comprises a first end located near the inlet end of the housing structure and a second end located at the outlet end of the housing structure.

11. The apparatus of claim 10 wherein the at least one manifold is two manifolds.

12. The apparatus of claim 10 further comprising a means for delivering a pressurized stream of a treatment fluid to the at least one manifold and plurality of spray nozzles fitted thereto.

13. The apparatus of claim 10 wherein the plurality of spray nozzles are fitted to the at least one manifold in a regularly or irregularly spaced fashion from a point at or near the first end of the at least one manifold to a point at or near the second end of the at least one manifold, and wherein each of the plurality of spray nozzles is fitted to the manifold so as to direct spray downward toward the foodstuffs being conveyed by the rotatable shaft having the plurality of paddles attached thereto and protruding therefrom.

14. The apparatus of claim 13 wherein at least one of the plurality of spray nozzles is configured to deliver a spray in the form of a fog.

15. The apparatus of claim 13 wherein at least one of the plurality of spray nozzles is configured to deliver a cone-shaped spray.

16. The apparatus of claim 13 wherein at least one of the plurality of spray nozzles is configured to deliver a fan-shaped spray.

17. The apparatus of claim 13 wherein the plurality of spray nozzles are configured so that the flow rate of the treatment fluid sprayed from any one of the plurality of spray nozzles may be the same as or different from the flow rate of the treatment fluid sprayed from any of the other spray nozzles.

18. The apparatus of claim 13 wherein the plurality of spray nozzles are configured so that the flow rate of the treatment fluid sprayed from spray nozzles fitted to the manifold toward its first end is greater than the flow rate of the treatment fluid sprayed from spray nozzles fitted to the manifold toward its second end.

19. The apparatus of claim 1 wherein the treatment fluid is a disinfectant or fungicide.

20. The apparatus of claim 19 wherein the disinfectant or fungicide is in the form of a liquid or fluidizable solids.

21. The apparatus of claim 20 wherein the disinfectant or fungicide is selected from the group consisting of acidified sodium chlorite solutions, aqueous chlorine dioxide solutions, quaternary ammonia compounds, per-acid compounds, hydrogen peroxide, organic acids, chlorine solutions, halogen-donor compounds, metal hypohalites, electrolyzed water, ozone solutions, natural floral or faunal extracts, enzymatic products, surface-active agents, and mixtures thereof.

22. The apparatus of claim 1 wherein the treatment fluid is a flavoring agent in the form of a liquid or fluidizable solids.

23. The apparatus of claim 1 wherein the treatment fluid is a tenderizing agent, texturizing agent, or preservative in the form of a liquid or fluidizable solids.

24. The apparatus of claim 1 wherein the housing structure comprises substantially planar first and second side-wall portions and a rounded bottom portion, the first and second side-wall and bottom portions forming a generally U-shaped cross-section when viewed along the length of the housing structure, and the diameter of the semi-circular portion of the U-shaped cross-section being slightly greater than the diameter of the largest circular arc traced by the plurality of paddles as the shaft rotates; wherein the housing structure forms an opening at the top, the opening extending along substantially the entire length of the housing structure and being of substantially uniform width.

25. The apparatus of claim 24 wherein the shaft is adapted to rotatably convey and tumble the foodstuffs from the inlet end of the housing structure to the outlet end of the housing structure as the shaft rotates in a direction that is clockwise when the rotation is viewed from the inlet end toward the outlet end, and wherein the at least one manifold of the fluid delivery system is located closer to the first side-wall than to the second side-wall.

26. The apparatus of claim 24 further comprising a hingedly connected or removable top configured to cover the opening when closed or installed.

27. The apparatus of claim 26 wherein the fluid delivery system is enclosed within the housing structure when the top is closed or installed.

28. The apparatus of claim 24 wherein neither end of the housing structure is substantially elevated in relation to the other end.

29. The apparatus of claim 24 wherein the inlet end of the housing structure is elevated in relation to the outlet end.

30. The apparatus of claim 24 wherein the outlet end of the housing structure is elevated in relation to the inlet end.

31. The apparatus of claim 30 wherein the outlet end of the housing structure is elevated in relation to its inlet end to an extent such that the shaft is at an angle of about 10° to about 20° from the horizontal.

32. The apparatus of claim 30 wherein the shaft is at an angle of about 15° from the horizontal.

33. The apparatus of claim 24 wherein the housing structure comprises at least one leg having an adjustable height.

34. The apparatus of claim 24 wherein the bottom portion of the housing structure comprises a drain located at the inlet end of the housing structure.

35. The apparatus of claim 1 wherein the foodstuffs are in whole form or in parts thereof.

36. The apparatus of claim 35 wherein the foodstuffs comprise meat.

37. The apparatus of claim 35 wherein the foodstuffs comprise seafood.

38. The apparatus of claim 35 wherein the foodstuffs comprise fruits.

39. The apparatus of claim 35 wherein the foodstuffs comprise vegetables.

40. The apparatus of claim 1 wherein the plurality of paddles attach to the shaft along a generally helical path, and wherein the paddles are aligned along a generally spiral plane projecting outwardly from the helical path.

41. The apparatus of claim 40 wherein the plurality of paddles are interconnected by a web, the web being connected to the rotatable shaft; wherein the web and interconnected plurality of paddles form a continuous, generally spiraling surface along an operable length of the shaft; and wherein the intersection of the continuous, generally spiraling surface and the rotatable shaft is continuous from a first end to a second end of the generally spiraling surface.

42. The apparatus of claim 41 wherein the generally helical surface is made of metal.

43. The apparatus of claim 42 wherein the metal is a stainless steel.

44. The apparatus of claim 41 wherein each of the plurality of paddles comprises a curved blade, each of the curved blades comprising a first portion and a second distal portion, the first portion being substantially aligned with the generally spiraling surface, and the second distal portion angling away from the generally spiraling surface and toward the outlet end of the housing structure.

45. An apparatus comprising:
an elongated housing structure extending from an inlet end to an outlet end along a longitudinal axis;
a shaft rotatably engaged with the housing structure to rotate about the longitudinal axis;
a spiral blade attached to and protruding from the shaft and continuously spiraling around the shaft, the shaft and blade being adapted to rotatably convey and tumble foodstuffs from the inlet end to the outlet end as the shaft rotates; and
a fluid delivery system adapted to apply a treatment fluid to the foodstuffs as they are rotatably conveyed, while agitated and tumbled, from the inlet end to the outlet end.

46. The apparatus of claim 45 wherein the housing structure comprises first and second side-wall portions and a bottom portion, the first and second side-wall and bottom portions forming a generally U-shaped cross-section when viewed along the length of the housing structure, and the diameter of the semi-circular portion of the U-shaped cross-section being slightly greater than the diameter of the spiral blade; wherein the housing structure forms an opening at the top, the opening extending along substantially the entire length of the housing structure and being of substantially uniform width.

47. The apparatus of claim 46 wherein the at least one manifold of the fluid delivery system is located closer to the first side-wall than to the second side-wall.

48. The apparatus of claim 45 wherein each flight of the spiral blade comprises one or more protrusions attached thereto, each of the one or more protrusions continuously extending radially from the shaft to, or near to, the distal edge of the spiral blade, protruding from the surface of the spiral blade in the direction of conveyance of the foodstuffs, and having a leading edge.

49. The apparatus of claim 48 wherein the cross-section of each of the one or more protrusions, the cross-section being in a plane tangential to the shaft and perpendicular to the leading edge of the protrusion, is substantially elongated, the direction of elongation being in the direction of conveyance of the foodstuffs or foodstuff parts.

50. The apparatus of claim 49 wherein the cross-section is generally triangular or V-shaped, the triangle or V-shape narrowing in the direction of conveyance of the foodstuffs.

51. The apparatus of claim 48 wherein each flight of the spiral blade comprises one protrusion attached thereto.

52. The apparatus of claim 48 wherein each flight of the spiral blade comprises two protrusions attached thereto.

53. The apparatus of claim 48 wherein each flight of the spiral blade comprises three protrusions attached thereto.

54. The apparatus of claim 48 wherein each flight of the spiral blade comprises four protrusions attached thereto.

55. The apparatus of claim 54 wherein the angle of rotation from one protrusion to the next along a flight of the spiral blade is about 90°.

56. The apparatus of claim 48 wherein each flight of the spiral blade comprises more than four protrusions attached thereto.

57. The apparatus of claim 48 wherein the protrusions are welded to the helically-shaped blade.

58. The apparatus of claim 48 wherein the protrusions are integral with the helically-shaped blade.

59. The apparatus of claim 48 wherein the protrusions are removeably attached to the helically-shaped blade.

60. The apparatus of claim 45, further comprising a plurality of paddles wherein the spiral blade is attached to and protrudes from a first longitudinal portion of the rotatable shaft, and the plurality of paddles is attached to and protrudes from a second longitudinal portion of the rotatable shaft.

61. The apparatus of claim 60 wherein the first longitudinal portion extends from that end of the rotatable shaft closest to the inlet end of the housing structure to a point about one-third of the way to the other end of the rotatable shaft.

62. The apparatus of claim 60 wherein the first longitudinal portion extends from that end of the rotatable shaft closest to the inlet end of the housing structure to a point about one-half of the way to the other end of the rotatable shaft.

63. A method for applying a treatment fluid to surfaces of foodstuffs, comprising the steps of:
introducing foodstuffs into an inlet end of an elongated apparatus;
introducing, by means of a fluid delivery system, an effective amount of a treatment fluid into the apparatus so as to effect contact between the treatment fluid and substantially all of the surfaces of the foodstuffs as the latter are rotatably conveyed, while agitated and tumbled, from an inlet end to an outlet end of the apparatus, the effective amount of the treatment fluid realized by having 1) a sufficient flow rate of the treatment fluid from the fluid delivery system into the apparatus per unit mass of foodstuffs treated, and 2) a sufficiently long time of travel of the foodstuffs from the inlet end to the outlet end of the apparatus.
